(19) United States
(12) Patent Application Publication
(10) Pub. No.: US 2014/0096642 A1
(43) Pub. Date: Apr. 10, 2014

(54) STARTER MOTOR

(71) Applicant: REMY TECHNOLOGIES, LLC, Pendleton, IN (US)

(72) Inventors: Joel Gray, Fishers, IN (US); David Fulton, Anderson, IN (US); Kirk Neet, Pendleton, IN (US); Balazs Palfai, Fishers, IN (US)

(21) Appl. No.: 13/646,515

(22) Filed: Oct. 5, 2012

(51) Int. Cl. F02N 11/00

(52) U.S. Cl. CPC F02N 11/00
USPC 74/7 C

(57) ABSTRACT

Embodiments of the invention provide a starter comprising a motor comprising a drive shaft, a pinion, and a clutch. In some embodiments, the starter includes a planetary gear coupled with the clutch. Some embodiments include a pinion speed sensor assembly configured and arranged to provide a signal related to the rotational speed of the pinion based upon a speed of a component of the starter that is coupled to the pinion. Some embodiments of the starter include a pinion rotational speed sensor located within the drive-end region of the starter, and configured and arranged for direct or indirect monitoring of the pinion. Some embodiments include a sensor that is configured and arranged to monitor one or more components of the clutch assembly, the drive-shaft, the pinion, the output shaft, or a planetary gear. The speed sensor can be a magnetic-field flux sensor assembly or an optical sensor assembly.

### BACKGROUND

Some electric machines can play important roles in vehicle operation. For example, some vehicles can include a starter, which can, upon a user closing an ignition switch, lead to cranking of engine components of the vehicle. Drive train systems capable of frequent start and stop conditions are a further requirement in modern vehicles. Frequent start-stop conditions require the starter to operate at high efficiency both at cold engine crank and warm engine crank environments. The demands of frequent start-stop conditions require various components and systems that function more rapidly and more efficiently to increase reliability, reduce energy consumption and enhance the driving experience. Some starters can include a one or more sensor assemblies for detection of various functional components of the start motor, and a control system capable of directing various functional components of the starter system to enable reliable, synchronous engagement.

### SUMMARY

Some embodiments of the invention comprise electric starter machines that utilize starters with much higher speed operation than conventional starters. These high speed starters can have ring gear to pinion gear ratios reaching 10-15:1 in advanced designs with an internal gear ratio of 3.6-5:1. Armature speeds of the starter can easily reach into the 30,000+ RPM range, and these high speeds can create forces that in turn cause failure of the commutator or armature winding. Increasing vehicle efficiency and reliability demands are driving the need for starting motors that are integrated within electric machine start-stop systems where the starter may be required to provide lifetime operational range of 300,000 to 400,000 start cycles.

Some embodiments of the invention provide a starter that can perform well at high-speeds having low torque demand while also operating well at low speeds having high torque demanded of the starter. In some embodiments, the starter is able to meet the cold crank requirement and function under a warm start scenario while reducing the pinion speed at low pinion torque. In conjunction with this operating parameter, some embodiments of the invention provide components and systems that are configured and arranged to function to allow better engagement of the starter system with the drivetrain of the vehicle.

Some embodiments of the starter include at least one pinion rotational speed sensor located within the drive-end region of the starter, configured and arranged for direct measurement of the pinion, or of a component coupled to the pinion of the starter.

In some embodiments, the speed sensor can comprise a sensor assembly that includes a Hall effect sensor, or some other magnetic-field flux sensor assembly. In some embodiments, the magnetic-field flux sensor measures the inherent magnetic flux of the pinion, or one or more components coupled to the pinion. In some other embodiments, a magnetic field flux emitter is coupled to the pinion or one or more components of the pinion and the sensor is configured and arranged to measure the magnetic field flux.

In some further embodiments, the sensor obtains a signal from a sensor target that comprises an indentation or protrusion in the pinion, or one or more components coupled to the pinion. In some embodiments, the sensor target comprises one or more teeth of the pinion, one or more components of the clutch assembly, one or more components of the drive-shaft axially, one or more components of the drive-shaft radially, one or more components of the planetary gear teeth axially, or one or more components of the planetary gear teeth radially.

In alternative embodiments, the sensor assembly comprises an optical sensor assembly. In some embodiments, the sensor assembly provides pinion speed information to one or more components coupled to the starter.

### DESCRIPTION OF THE DRAWINGS

FIG. 1 is a diagram of a machine control system according to one embodiment of the invention.

FIG. 2 shows cross-sectional view of a conventional starter

FIG. 3 shows an illustration of a starter with integrated sensors on the pinion side according to one embodiment of the invention.

FIG. 4 shows a flowchart illustrating a pre-change of mind start algorithm according to one embodiment of the invention.

FIG. 5 shows an illustration of a solenoid assembly according to one embodiment of the invention

FIG. 6 shows an illustration of a starter according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

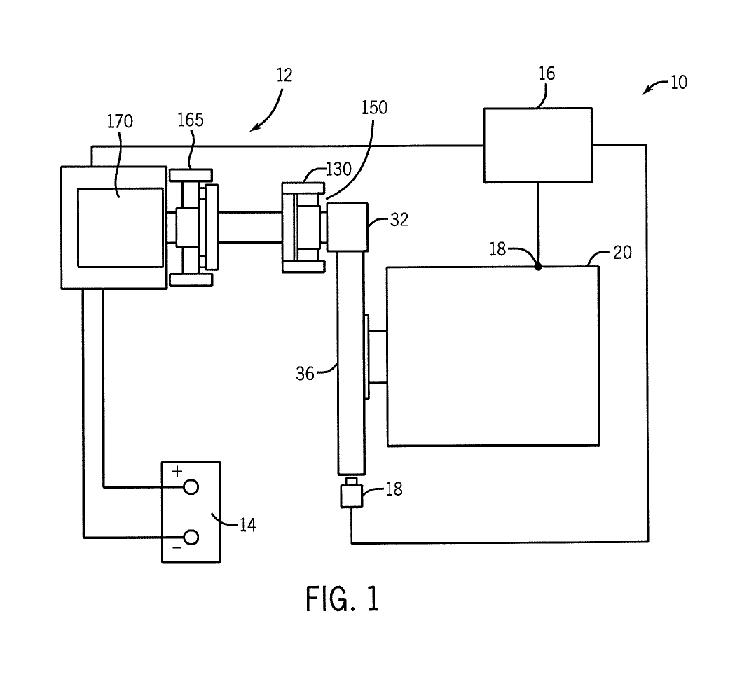

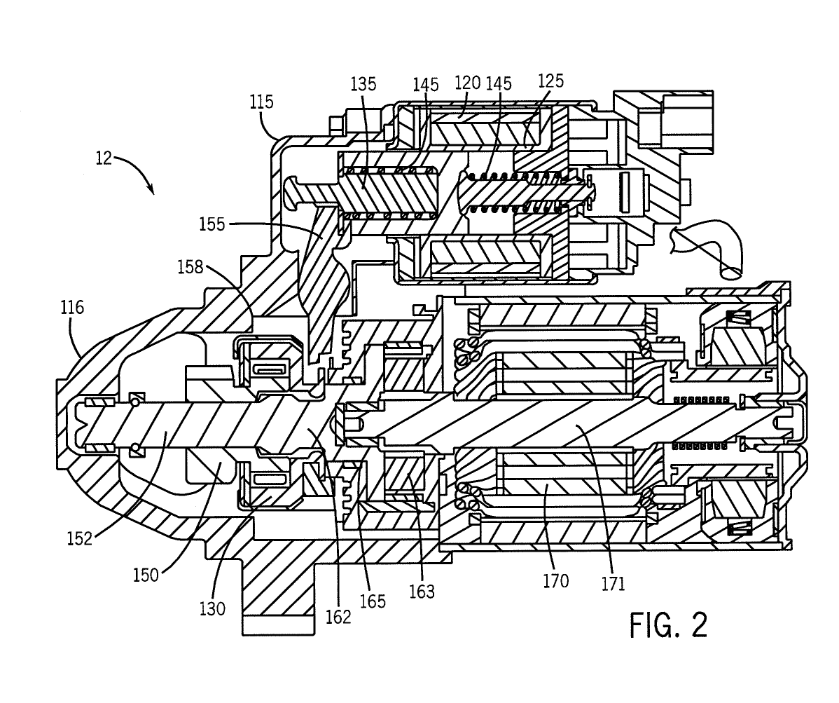

FIG. 1 illustrates a starter control system 10 according to one embodiment of the invention. The system 10 can include a starter 12 including a motor 170, a power source 14, such as a battery, an engine control unit 16, one or more sensors 18 for detection of engine speed, (in this case shown as the detection of ring-gear speed), and an engine 20, such as an internal combustion engine. In some embodiments, the system 10 can include a pinion 150 located on an output shaft 152 (as shown in FIG. 2) coupled to the motor 170 via a gear train 165 and a clutch 130. In some embodiments, a vehicle, such as an automobile, can comprise the system 10, although other vehicles can include the system 10. In some embodiments, one or more of the sensors 18 can comprise an engine speed sensor 18 configured and arranged to detect and transmit data to the engine control unit 16 that correlates to the speed of the engine 20, the crankshaft, and/or the ring gear 36. In some embodiments, the engine speed sensor 18 can communicate with the engine control unit 16 via wired and/or wireless communication protocols. In some embodiments, non-mobile apparatuses, such as stationary engines, can comprise the system 10.

In addition to the conventional engine 20 starting episode (i.e., a “cold start” starting episode), the starter control system 10 can be used in other starting episodes. In some embodiments, the control system 10 can be configured and arranged to enable a “stop-start” starting episode. For example, the control system 10 can start an engine 20 when the engine 20 has already been started (e.g., during a “cold start” starting episode) and the vehicle continues to be in an active state (e.g., operational), but the engine 20 is automatically temporarily inactivated (e.g., the engine 20 has substantially or completely ceased moving at a stop light).

Moreover, in some embodiments, in addition to, or in lieu of being configured and arranged to enable a stop-start starting episode, the control system 10 can be configured and arranged to enable a “change of mind stop-start” starting episode. The control system 10 can start an engine 20 when the engine 20 has already been started by a cold start starting episode and the vehicle continues to be in an active state and the engine 20 has been automatically deactivated, but continues to move (i.e., the engine 20 is coasting). For example, after the engine 20 receives a deactivation signal, but before the engine 20 substantially or completely ceases moving, the user can decide to reactivate the engine 20 (i.e. vehicle operator removes his foot from the brake pedal) so that the pinion 150 engages the ring gear 36 as the ring gear 36 is coasting. After engaging the pinion 150 with the ring gear 36, the motor 170 can restart the engine 20 with the pinion 150 already engaged with the ring gear 36. In some embodiments, the control system 10 can be configured for other starting episodes, such as a conventional “soft start” starting episodes (e.g., the motor 170 is at least partially activated during engagement of the pinion 150 and the ring gear 36).

The following discussion is intended as an illustrative example of some of the previously mentioned embodiments employed in a vehicle, such as an automobile, during a starting episode. However, as previously mentioned, the control system 10 can be employed in other structures for engine 20 starting.

As previously mentioned, in some embodiments, the control system 10 can be configured and arranged to start the engine 20 during a change of mind stop-start starting episode. For example, after a user cold starts the engine 20, the engine 20 can be deactivated upon receipt of a signal from the engine control unit 16 (e.g., the vehicle is not moving and the engine 20 speed is at or below idle speed, the engine control unit 16 instructs the engine 20 to inactivate after the vehicle user depresses a brake pedal for a certain duration, etc.), the engine 20 can be deactivated, but the vehicle can remain active (e.g., at least a portion of the vehicle systems can be operated by the power source 14 or in other manners). At some point after the engine 20 is deactivated, but before the engine 20 ceases moving, the vehicle user can choose to restart the engine 20 by signaling the engine control unit 16 (e.g., via releasing the brake pedal, depressing the acceleration pedal, etc.) which will cause the pinion 150 to be automatically engaged with the ring gear 36. For example, in order to reduce the potential risk of damage to the pinion 150, and/or the ring gear 36, a speed of the pinion 150 (the pinion speed multiplied by the ring/pinion gear ratio) can be substantially synchronized with a speed of the ring gear 36 (i.e., a speed of the engine 20) when the starter 12 attempts to engage the pinion 150 with the ring gear 36. The engine control unit 16 can then use at least some portions of the starter control system 10 to restart the engine 20.

FIG. 2 is a cross-sectional view of a conventional starter 12. The starter 12 comprises a housing 115, a motor 170 including a shaft 171, a gear train 165, a solenoid assembly 125, a clutch 130 (e.g., an over-running clutch), and a pinion 150 In some embodiments, the starter 12 can operate in a generally conventional manner. For example, in response to a signal (e.g., a user closing a switch, such as an ignition switch), the solenoid assembly 125 can cause a plunger 135 to move the pinion 150 into an engagement position with a ring gear 36 of a crankshaft of an engine (not shown). Further, the signal can lead to the motor 170 generating an electromotive force, which can be translated through the gear train 165 to the pinion 150 engaged with the ring gear 36. As a result, in some embodiments, the pinion 150 can move the ring gear 36, which can crank the engine leading to engine ignition.

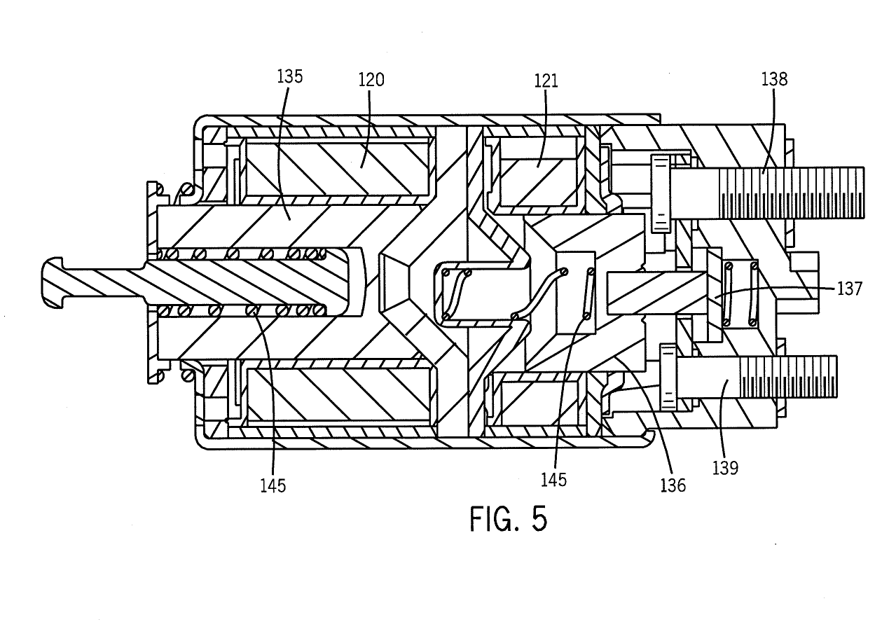

In some embodiments, the starter 12 can comprise multiple configurations. For example, in some embodiments, the solenoid assembly 125 that allows for the speed synchronization is shown in FIG. 5 the solenoid assembly 125 can comprise one or more configurations. In some embodiments, the solenoid assembly 125 can comprise the pinion plunger 135, a pinion coil 120, and a plurality of biasing members 145 (e.g., springs or other structures capable of biasing portions of the solenoid assembly 125), a motor coil 121 and a motor plunger 136. In some embodiments, a first end of a shift lever 155 can be coupled to the pinion plunger 135 and a second end of the shift lever 158 can be coupled to the clutch 130 and/or a drive shaft 162 that can operatively couple together the motor 170 and the pinion 150. As a result, in some embodiments, the activation of the pinion coil 120 causes the pinion plunger 135 to move which is then transferred to the pinion 150 via the shift lever 155, 158 to engage the pinion 150 with the ring gear 36. In the same embodiment the motor coil 121 is activated to cause the motor plunger 136 to move which closes the switch 137 which sends power from the battery bolt 138 to the motor bolt 139 and finally to the motor 170 to cause the motor to spin. The synchronization process occurs as follows; the motor coil 121 is activated first, and when the pinion and ring gear speeds are synchronized, the pinion coil 120 is activated to engage the pinion 150 with the ring gear.

In some further embodiments, the starter 12 can comprise multiple configurations including one or more sensors. One or more sensors may be added to the control system 10 to facilitate measurement of the rotation speed of the pinion 150. For example, in some embodiments, pinion rotation speed data may be used by the control system 10 to enhance the meshing of the pinion 150 and the ring gear 36, thereby enabling a completion of the synchronization process previously mentioned. By utilizing a combination of measured values for the pinion speed with data already available in engine control systems for the ring gear speed, a control system 10 can more optimally compute and control the necessary synchronization of the speed of the ring gear 36 (i.e., a speed of the engine 20) to provide substantially synchronized engagement when the starter 12 attempts to restart the engine 20.

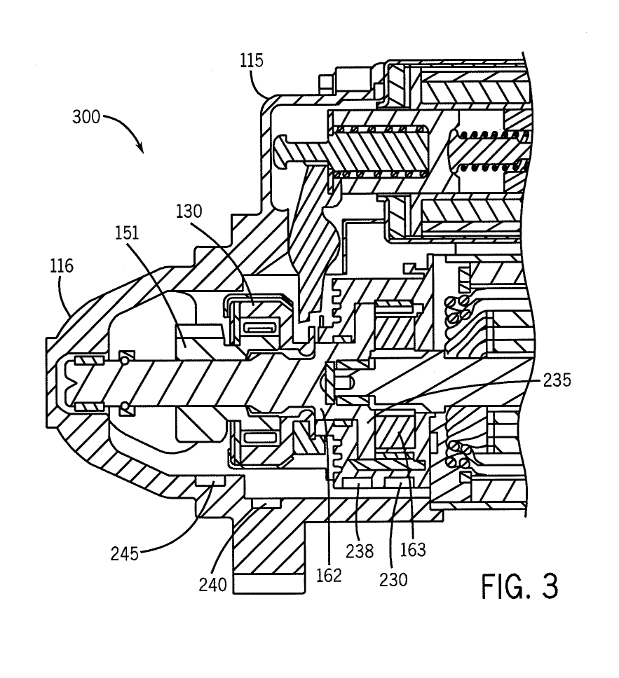

Referring now to FIG. 3 illustrating a starter 300, some embodiments of the invention include one or more sensors coupled to the starter 300 on the pinion side of the starter (shown as 230, 235, 240, 245). As shown in FIG. 3, in some embodiments, one or more of the sensors can be coupled to, integrated with, or embedded into at least one component of the starter 300 on the pinion 150 side of the starter 300. For example, in one embodiment of the invention, the pinion speed sensor assembly 245 is located within or substantially near the drive-end housing 116 of the starter 300. The assembly 245 is located substantially within or adjacent to the pinion teeth 151 and is configured and arranged to sense information relating to the speed of the pinion teeth 151. In another embodiment of the invention, the pinion speed sensor assembly 240 is located within or substantially near the drive-end housing 116 of the starter 300. The assembly 240 is located substantially within or adjacent to the over-running clutch 130, and is configured and arranged to sense the over-running clutch 130.

In one embodiment of the invention, the pinion speed sensor assembly 235 is located within or substantially near the drive-end housing 116 of the starter 300. The assembly 235 is located substantially within or adjacent to the drive shaft 162, and is configured and arranged to axially sense a target on the drive shaft 235. In some other embodiments, the pinion speed sensor assembly 238 is substantially within or adjacent to the drive shaft and is configured and arranged to radially sense a target on the drive shaft 162.

In another embodiment of the invention, the pinion speed sensor assembly 230 is located within or substantially near the drive-end housing 116 of the starter 300. The assembly 230 is located substantially within or adjacent to the planetary gears 163, and is configured and arranged to radially sense the teeth of the planetary gears 163.

In some embodiments, a sensor target may be used in combination with the sensor. For example, in one or more of the embodiments, the sensor target may be one or more indentations or protrusions formed within or on one or more components of the over-running clutch and is integral to the structure of the over-running clutch. In some other embodiments, the sensor target may comprise one or more indentations or protrusions formed within, or on one or more components of the drive shaft and is integral to the structure of the drive shaft.

In some embodiments, one or more of the sensor assemblies 230, 235, 238, 240, 245 can comprise a Hall effect sensor. A Hall effect sensor is a transducer that varies its output voltage in response to a magnetic field, and can be used for speed and proximity detection, or relative position when using more than one sensor. In some other embodiments, the sensor may comprise some other proximity sensor or speed measuring device sensitive to magnetic field flux. For example, the sensor may comprise a magnetic flux coil such as a Helmholtz coil, or some other magnetic coil sensitive to magnetic field flux variation. In some other embodiments, a variable reluctance sensor may be used.

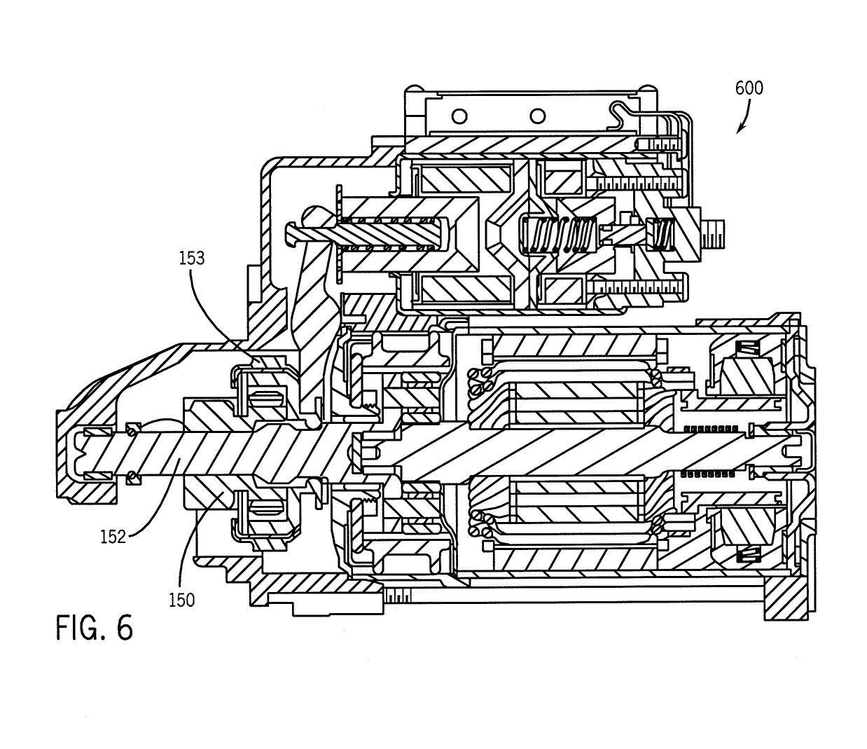

In other embodiments of the invention, the sensor target may be a material or other structure that is able to be sensed by the pinion speed sensor assembly or may comprise a secondary member mounted to, integrated or embedded with, or associated with the over-running clutch assembly 130, pinion 150 or output shaft 152. In some other embodiments, the sensor target may be a wheel 153 having teeth mounted on the clutch 130 (e.g. as shown in FIG. 6 in starter 600), and the teeth can be sensed (by for example by the sensor 240 as shown in FIG. 3). In other embodiments of the invention, the sensor target may be a material or other structure that is able to be sensed by the pinion speed sensor assembly that comprises a secondary member mounted to, or integrated or embedded with, or associated with the drive shaft 162 or the output shaft 152.

In some embodiments, the sensor target can be a magnet. A magnet can be used to provide a source of magnetic flux that is configured and arranged with one or more components of the starter. The magnet may provide a magnetic field flux for detection by one or more sensor assemblies sensitive to magnetic field flux. In some embodiments, the magnet can comprise a permanent magnet. In some embodiments, the magnet can comprise a ferromagnet, a ferrite, a magnetic alloy, or other material with high coercivity. In some other embodiments, the magnet can comprise an electromagnet or electromagnetic coil, or both. In some embodiments, the magnet is attached to the measured component, whereas in other embodiments the magnet is integrated or embedded with the component. In some other embodiments, the magnet is located adjacent the component to be measured and the sensor assembly is attached to, or coupled with the component to be measured. In some other embodiments, the sensor target is a functional component of the electric machine that comprises a magnetic material at a concentration that is high enough to provide a magnetic field flux that can be detected by the sensor. In this case, no additional sensor target is required because the one or more sensors can be configured and arranged to measure the inherent magnetic field flux from the component.

In some other embodiments, an optical sensor assembly can be used. For example in some embodiments, the optical sensor assembly can comprise an optical emitter, (i.e. a light source), and an optical sensor. The optical emitter can comprise an LED, an optical fiber, a laser such as a semiconductor laser or other conventional laser, an infrared source, a UV source, or a radioactive source. The optical sensor may comprise a photodiode, a phototransistor, a camera, or other type of electro-optical sensor. In some embodiments, the optical sensor and emitter are combined wherein the optical sensor assembly relies on the optical reflective properties of the component to be sensed.

In some embodiments, the optical sensor assembly is attached to the component to be measured, while in other embodiments the optical sensor assembly is adjacent to or integrated with or embedded with the component to be measured. In some further embodiments, a passive optical emitting material, such as a phosphorescent or fluorescent material is used in combination with the optical sensor assembly for detection. In this particular embodiment, the optical assembly can be placed adjacent, or within line-of-sight of the component to be measured, and the component comprises a surface marking comprising the passive optical emitting material that is configured and arranged to emit an optical signal following optical illumination by the optical emitter of the optical sensor assembly.

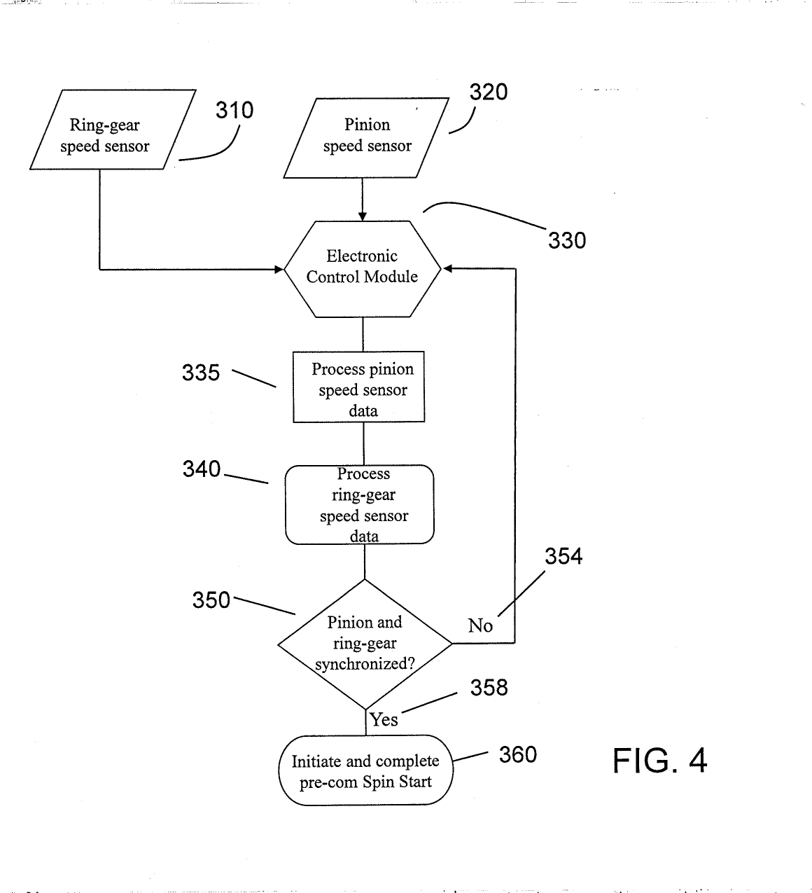

FIG. 4 shows a flowchart illustrating a pre-change of mind start algorithm according to one embodiment of the invention. In some embodiments of the invention, an engine control module 330, (shown as 16 in FIG. 1), is configured and arranged to receive data from at least one engine ring-gear speed sensor 310. The ring-gear speed sensor 310 may be one or a plurality of sensors within the engine that provides information to directly, or indirectly compute the engine speed and ring gear speed. The ring-gear sensor 310 may measure a physical parameter directly from the ring-gear 36 of the engine 20, or may measure another parameter of the engine 20. The engine control module 330 may use the data obtained from one or more engine sensors 18 to directly calculate the ring-gear speed, or it may use other information from other sensors, or from data stored in the engine control module 310, or elsewhere to calculate the ring-gear rotational speed.

In some embodiments of the invention, an engine control module 330 is configured and arranged to receive data from at least one pinion speed sensor 320. The pinion speed sensor 320 may be one or a plurality of sensors within the starter 300 that provides information to directly, or indirectly compute the pinion rotational speed. The pinion sensor may measure a physical parameter directly from the pinion 150 of the engine, or may measure another parameter of the pinion 150 or other component of the starter. The engine control module 330 may use the data obtained from one or more pinion speed sensor assemblies to directly calculate the pinion rotational speed, or alternatively it may use other information from other sensors, or from data stored in the engine control module 330, or elsewhere, to calculate the pinion rotational speed. In some embodiments, the engine control module 330 can process data received from the one or more ring-gear sensors and pinion speed sensors to determine the rotational speed of the ring-gear 36 and the rotational speed of the pinion 150, (shown as 335 and 340 in FIG. 3). The engine control module 330 may determine that the difference in the speed of the ring-gear 36 and the rotational speed of the pinion 150, (shown as 350), and based on the level of difference, perform a control function. In some embodiments the engine control module 330 may determine that the level of difference is too large 354, or not at a level or range to allow an acceptable engagement of the ring-gear 36 and the pinion 150. In some embodiments, the engine control module 330 can delay the engagement of the pinion 150 and ring-gear 36 of the engine at least partially based on data received from the pinion rotational speed sensor and the engine speed sensor if the engine control module 330 determines the difference is too large. In other embodiments of the invention, the engine control module 330 may determine that the level of difference is low enough to provide an acceptable engagement of the ring-gear 36 and the pinion 150. In some embodiments, the engine control module 330 can control the engagement of the pinion 150 and ring-gear 36 of the engine at least partially based on data received from the pinion rotational speed sensor and the engine speed sensor if the engine control module 330 determines the difference is within an acceptable range. In some embodiments, the engine control module can control the engagement of the pinion 150 and ring gear 36 at sufficiently synchronous speeds by meshing the pinion 150 and the ring gear 36 when the difference between the ring gear speed and the pinion speed is detected or predicted to be at a minimum or less than a predetermined value.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A starter comprising:
a motor comprising a drive shaft coupled to;
a pinion;
a clutch; and
a pinion speed sensor assembly including at least one sensor; wherein the sensor is configured and arranged to directly or indirectly sense the pinion speed and provide a signal related to the rotational speed of the pinion.

2. The starter of claim 1 further comprising a planetary gear coupled with the clutch.

3. The starter of claim 1 wherein the sensor comprises a magnetic flux sensor assembly.

4. The starter of claim 3 wherein the magnetic flux sensor assembly comprises a Hall Effect sensor.

5. The starter of claim 1 wherein the pinion speed sensor assembly further comprises a sensor target.

6. The starter of claim 5 further comprising an output shaft coupled to the pinion.

7. The starter of claim 4 wherein the magnetic flux sensor assembly further comprises a sensor that is configured and arranged to sense the location of one or more teeth of the pinion.

8. The starter of claim 4 wherein the magnetic flux sensor assembly is configured and arranged to monitor one or more components of the clutch assembly.

9. The starter of claim 4 wherein the magnetic flux sensor assembly is configured and arranged to monitor one or more components of the drive-shaft axially.

10. The starter of claim 4 wherein the magnetic flux sensor assembly is configured and arranged to monitor one or more components of the drive-shaft radially.

11. The starter of claim 4 wherein the magnetic flux sensor assembly is configured and arranged to monitor one or more components of the planetary gear teeth axially.

12. The starter of claim 4 wherein the magnetic flux sensor assembly is configured and arranged to monitor one or more components of the planetary gear teeth radially.

13. The starter of claim 5 wherein the sensor target comprises the pinion.

14. The starter of claim 5 wherein the sensor target comprises an indentation in one or more components coupled to the pinion.

15. The starter of claim 5 wherein the sensor target comprises a protrusion in one or more components coupled to the pinion

16. The starter of claim 1 wherein the pinion speed sensor assembly comprises an optical sensor assembly.

17. The starter of claim 16 wherein the optical sensor assembly comprises a photodiode.

18. The starter of claim 16 wherein the optical sensor assembly further comprises a phototransistor.

19. The starter of claim 16 wherein the optical sensor assembly further comprises an optical fiber.

20. The starter of claim 16 wherein the optical sensor assembly further comprises a camera.

21. The starter of claim 16 wherein the optical sensor assembly further comprises an optical emitter

22. The starter of claim 17 wherein the optical emitter comprises at least one of an LED, an optical fiber a semiconductor laser, an IR emitter, a UV emitter or a radiation source, a fluorescent material and a phosphorescent material.

23. The starter of claim 5 wherein the sensor target comprises a wheel including teeth, the wheel mounted on the clutch.

24. The starter of claim 5 wherein the sensor target comprises a wheel including teeth, the wheel mounted on the pinion.

25. The starter of claim 6 wherein the sensor target comprises a wheel including teeth, the wheel mounted on the output shaft.
